(19) United States
(12) Patent Application Publication
(10) Pub. No.: US 2002/0198997 A1
(43) Pub. Date: Dec. 26, 2002

(54) System and method for on board maintenance instructions and records

(76) Inventors: Steven Eric Linthicum, Niskayuna, NY (US); Jeanette Marie Bruno, Saratoga Springs, NY (US); Christopher Allen Nafis, Vischer Ferry, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/681,882

(22) Filed: Jun. 20, 2001

(51) Int. Cl. G06F 15/16

(52) U.S. Cl. 709/227; 709/203

(57) ABSTRACT

A system and method for maintenance management for a given field asset is provided. The system comprises a portable computing device disposed on the field asset and adapted to store the complete maintenance history, service instructions, and related technical information for the given field asset and further adapted to retrieve at least one of a plurality of maintenance information corresponding to the given field asset and a communication network coupled to the portable computing device and to at least one source of maintenance information to provide updates to at least one of a plurality of maintenance information for use in servicing the given field asset. The method comprises the steps of storing a maintenance history on a computing device disposed on the field asset, periodically querying a remote communication network for required maintenance events for the field asset and/or updates to maintenance information pertaining to the field asset, retrieving the required maintenance events from the remote communication network for use in servicing the field asset, and updating the communication network from the computing device upon completion of the required maintenance events.

### BACKGROUND OF INVENTION

This invention relates to a method and system for managing maintenance information between a central maintenance information source and equipment at a remote location, for example a railroad locomotive, medical equipment, power delivery systems or aircraft engines.

Generally, field service personnel responsible for the maintenance of complex equipment in the field rely on a variety of sources of information to perform the needed diagnostics, service or repair on a particular piece of equipment. Generally, many paper-based sources of information such as operation manuals, service logs, performance records and maintenance instructions have been computer-enabled. In the computer-enabled environment, service technicians or field service personnel are able to connect via a personal portable unit, for example a portable computer or hand-held computer, to a central diagnostic center or a central maintenance repository of logs or instructions. Thereafter, the technician is able to download current instructions and information for a particular piece of equipment.

While the computer-enabled environment greatly facilitates improved productivity and current information, the configuration management for tracking maintenance records and applicable instructions remains generally problematic. Typically, field equipment of a particular type may have a variety of fielded configurations, each having its own unique technical support documentation. Even for a specific model (identified by a model number), there may be several configurations as subsystems were redesigned or changed during the model production run. Maintenance records are similarly unique. Additionally, multiple and diverse service groups are often responsible for some aspects of service. Reliably tracking which parts are on a particular piece of equipment and what service operations have been performed is dependent upon the accuracy and diligence of the many service groups performing the appropriate record keeping. The recorded data is often inaccurate and/or scattered over different record keeping systems in such a manner as to make a complete maintenance history difficult, and often impossible, to obtain.

What is needed is a system and method for managing maintenance information for field equipment, and in particular for managing field equipment configuration history.

### SUMMARY OF INVENTION

In a first aspect, a maintenance management system for a given field asset is provided. The system comprises a communication device disposed on the field asset and adapted to store a maintenance history for the given field asset and further adapted to retrieve at least one of a plurality of maintenance information corresponding to the given field asset and a communication network coupled to the communication device and to at least one source of maintenance information to provide the at least one of a plurality of maintenance information for use in servicing the given field asset.

In a second aspect, a method for maintenance management of a given field asset is provided. The method comprises the steps of storing a maintenance history on a computing device disposed on the field asset, periodically querying a remote communication network for updates on maintenance events for the field asset, retrieving the updates from the remote communication network for use in servicing the field asset, and updating the communication network from the computing device upon completion of the required maintenance events.

### BRIEF DESCRIPTION OF DRAWINGS

The features and advantages of the present invention will become apparent from the following detailed description of the invention when read with the accompanying drawings in which:

FIG. 1 is a block diagram of a maintenance management system embodying the inventive aspects of the present invention; and,

FIG. 2 illustrates an exemplary process flow 100 of a method for maintenance management of a field asset employing aspects of the present invention.

### DETAILED DESCRIPTION

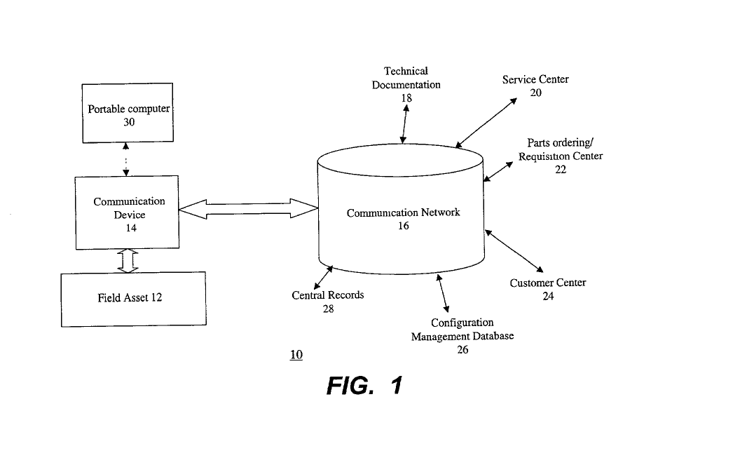

FIG. 1 is a block diagram of a maintenance management system 10 embodying the inventive aspects of the present invention. A field asset 12 is the equipment for which maintenance or service is to be performed. Field asset 12 for exemplary purposes only is a railroad locomotive. However, the teachings of the present invention may be applied to other types of field assets especially as part of a large fleet such as trucks, ships, off-road vehicles, airplanes, etc. Further, the teaching of the present invention may be applied to other field equipment. Generally, machines requiring field service are of a type that remain at the field site, and are desirably serviced at a field site since it is generally not possible or desirable to return the machine to the place of manufacture. Examples of such machines are air craft engines, weapon systems, other military equipment, medical imaging devices such as computed tomography (CT) machines, magnetic resonance imaging (MRI) machines, mammography machines, ultrasound machines, x-ray machines and other large field equipment such as power turbines, locomotives, and the like. Although the present invention is described in connection with locomotive equipment and machines, the systems and methods of the present invention can be used and applied in connection with other electrical and mechanical machines, such as, for example, automotive engines, appliances, power and utility service equipment and office equipment.

A communication device 14 is connected to field asset 12 and adapted to communicate with field asset 12 and a communication network 16 in a manner described in greater detail below. As used herein, “adapted to”, “configured” and the like refer to mechanical or structural connections between elements to allow the elements to cooperate to provide a described effect; these terms also refer to operation capabilities of electrical elements such as analog or digital computers or application specific devices (such as an application specific integrated circuit (ASIC)) that are programmed to perform a sequel to provide an output in response to given input signals.

A portable computer 30, or alternatively a portable computing device, is adapted to store the most recent maintenance instructions and maintenance data collection applications. As used herein, computer refers generally to computing devices capable of performing the described functions and for exemplary purposes only is referred to as a computer. Further, portable computer 30 desirably includes a mechanism that can be manually controlled and/or can be controlled by an automatic diagnostic application, for selecting the appropriate maintenance instructions and data collection application for a given service opportunity. Portable computer 30 desirably includes a robust storage capability (as used herein robust refers generally to be able to withstand extremes in temperatures, humidity and movement (vibration)) to store the instructions and maintenance data for field asset 12. Portable computer 30 is desirably an on-board computer and connected to field asset in a manner to allow the portable computer to be removed by a service technician during the service and maintenance at various locations on and about field asset 12. Portable computer 30 may also include a touch sensitive display unit in order to allow a service technician to view maintenance instructions and enter a record of the current service activities. Portable computer 30 is further adapted to communicate with communication network 16, via communication device 14 in any of the well-known wireless or wired communication systems and protocols, including an Internet connection using the TCP/IP (Transmission Control Protocol/Internet Protocol) protocols, tone modems, ISDN (Integrated Services Digital Network) or XDSL (Digital Subscriber Line) protocols over the public switched telephone network or a cable modem. Communication network 16 is generally a central repository linked to a variety of maintenance information sources. Examples of maintenance information sources include technical documentation 18, a service center 20 for repair/maintenance recommendations, a parts ordering/requisition center 22, a customer center 24 for customer requests, any configuration management databases 26 and any other sources or central records 28. Communication network 16 is adapted to communicate with the variety of maintenance information sources in any of the well-known wireless and wired communication protocols to enable the retrieval and delivery of selected maintenance information to be available for viewing at portable computer 30 by a service technician. Access via the Internet to information is desirably password protected, in one embodiment.

Portable computer 30 is further adapted to store configuration history for the field asset to which is it is mounted in order to preserve a full history of repairs, maintenance, parts and the like for the given field asset 12. In an embodiment of the present invention, portable computer 30 is a ruggedized computer selected from any of the well-known ruggedized computers with remote communications capability. Portable computer 30 is also adapted to provide on-board monitoring and diagnostic system of field asset 12. The on-board monitor monitors certain operational parameters on the field asset 12 and reports faults and anomalous conditions directly to the service center 20 via an independent communications system. The on-board monitoring system identifies faulty components and provides fault codes for use by the repair technician in diagnosing the problem. Also, the on-board monitoring system records the number of miles traveled, the amount of fuel consumed, the number of service hours, etc. Communication device 14 provides access to data stored in the on-board monitoring system and is adapted to transmit the data to any of the recipient sites shown in FIG. 1 (including the portable computer 30). This operational information is extremely important in the diagnostic and repair process. In some cases, depending upon the nature of the fault or anomalous condition, the on-board monitoring capability automatically transmits this information back to service center 20, where a repair recommendation is formulated and then made available to the portable computer, in a manner to be discussed further below.

In this embodiment, in addition to being adapted to provide diagnosis and monitoring, portable computer 30 is further adapted to house an application that supports the following aspects of maintaining the field asset: downloading the most recent maintenance instructions and maintenance record collection application; delivering maintenance instructions; collecting a record of maintenance activity for field asset 12; and, remotely transmitting the record of maintenance activities to a central record keeping computer. Thus, portable computer 30 is adapted to store a full history of repairs, parts, and maintenance for field asset 12. Further, portable computer 30 is adapted to retrieve instructions unique for the given field asset 12.

In a further embodiment, portable computer 30 is adapted to have a remote communications function for automatically downloading the most recent instructions and data collection applications from a remote computer and for automatically transferring a record of maintenance activities to a remote computer. This functionality is particularly applicable to mobile field assets, such as locomotives. The capability is desirably enabled by periodic checks by portable computer 30 to determine if communication device 14 is in communication range with communication network 16. When portable computer 30 determines there is a link to communication network 16, portable computer 30 automatically retrieves any maintenance instructions not yet completed and downloads the instructions onto portable computer 30. Thus, the most recent instructions are readily available at the next opportunity when a service technician has access to field asset 12. Thus, the service technician does not have to take the steps to query and retrieve the latest instructions.

Repair, maintenance, and diagnostic information are exchanged between portable computer 30 and a service center 20, a central site generally responsible for repair/maintenance instructions. Parts information is exchanged between the portable computer 30 and a parts requisition center 22. Finally, contractual information, such as warranty information, is exchanged with a customer center 24. Generally, the parts requisition center 22, the customer center 24, and service center 20 are located remote from where the field asset is to be serviced. Service center 20, parts ordering/requisition center 22, and customer center 24 are desirably linked via a global information network, such as the Internet and the World Wide Web, via an intranet or by point-to-point communications system, examples of which are discussed above. As described herein, a global information network is referred to generally as communication network 16, as shown in FIG. 1. Because the Internet provides the ability to communicate data and information in a multimedia format, it is especially useful for communicating and displaying the large amount of data associated with the repair, maintenance and diagnosis of field asset 12.

Portable computer 30 and communication device 14 are desirably selected to be further adapted to withstand the environmental conditions of field asset 12. For example, when field asset 12 is a locomotive, portable computer 30 and communication device 14 are desirably hardened devices (e.g. Panasonic Tough Book, devices by Intermec, Telxon, etc.) appropriately selected to withstand the extreme weather and vibration conditions experienced by a locomotive. When field asset 12 is a medical imaging device, portable computer 30 and communication device 14 are desirably selected so as not to interfere with imaging conditions, such as magnetic fields in Magnetic Resonance Imaging (MRI) systems.

Portable computer 30 provides the service technician access to a plethora of repair, diagnostic, and operational information needed to efficiently and accurately trouble shoot problems and undertake the necessary repairs for field asset 12. The communication device 14 downloads repair recommendations generated by analysis software and/or field asset repair experts at service center 20. From portable computer 30, the technician also has access to repair resources, such as textual repair manuals, field modification instructions, schematics, block diagrams, etc. Special software tools related to the repair task are also available at portable computer 30, as transmitted from the diagnostic service center 20 (via communication device 14). System 10 provides parts ordering and parts tracking via communications with parts ordering/requisition center 22. Portable computer 30 with a wireless connection to communication device 14 mounted, or otherwise disposed on, field asset 12 provides ready data access to service center 20. For example, repair experts at service center 20 may desirably provide individualized assistance to the technician via communication device 14 and portable computer 30, using an instant messaging feature incorporated therein. Further, problem resolution suggestions and repair actions can be created prior to access by the repair technician or they can be authored in real time by experts at service center 20 and immediately transmitted to portable computer 30. Additionally, the repair technician can also provide visual information, such as still or video images, back to service center 20 (over an Internet connection, for example) using a camera attached to portable computer 30. The video information may also be accompanied by live audio information (as spoken by the technician), thereby allowing the technician to communicate with personnel at service center 20 to confer about a particular problem or repair action.

In a further embodiment, portable computer 30 is adapted to decode bar code information during the execution of a repair instruction. For example, a bar code reader (not shown) is attached to portable computer 30. The bar code reader can be used to decode the bar code information and store the information locally and/or transmit the decoded information (or the bar code itself) to service center 20 over the communication links previously described.

Thus, the combination of portable computer 30 and communication device 14 and its various interfaces described above substantially replace the conventional paper-based and manual information sources, thereby simplifying and expediting the repair process. Upon completion of the repair or service, portable computer 30 is configured to store the description of the problem, the repair actions taken, and any part changes or replacements to maintain a full history of field asset 12. Further upon completion of the repair, portable computer 30 is adapted to send a feedback status describing the nature of the problem and the repair actions taken to service center 20, where it will be included with the repair history stored at service center 20 for that field asset.

In essence, the present invention provides the technician with all the information he/she needs to effectively conduct the diagnosis and repair procedures, relying on information that is transmitted from sources distant from the repair site. Having all this information available, including help from repair experts, avoids the use of paper copies, and ensures a quick and accurate diagnosis and repair of the locomotive 12. Further, via portable computer 30 and communication device 14, the technician is able to request individualized expert assistance from service center 20 when problems or issues arise that he/she is incapable of handling. Additionally, portable computer 30 and communication device 14 are adapted to provide feedback of a repair action taken to a central record source and to store a full repair history that remains with field asset 12.

Service center 20 is generally operated by personnel who are experts in trouble shooting the various field assets. Information received about field asset 12 from the portable computer 30 is electronically processed and then visually displayed to these repair experts. The repair expert analyzes the information and produces a recommendation identifying the potential root cause or root causes of the problem. The repair information is then delivered to the portable computer 30 for execution of the recommended actions in a timely fashion, providing an enhanced degree of accuracy in carrying out the repair procedure.

Embodiments of the present invention are applicable to various maintenance procedures to be performed on field asset 12. There are at least three different categories of maintenance procedures to be performed on field asset 12. The first are predictive in nature. That is, based on information downloaded in ways described above from field asset 12, experts at service center 20 are able to determine that a given component of field asset 12 may be on a path toward eventual failure. Portable computer 30 will store the most recent instructions for the replacement and a service technician will be alerted to replace this component to avoid a failure of field asset 12 while it is in operation. A second category of maintenance procedures is a planned procedure, such as routine maintenance that is planned in advance to occur on a predetermined schedule. These are otherwise known as planned maintenance. Planned maintenance can be based on operational considerations such as, for example, the number of service hours, the number of images, or the number of miles traveled since the last maintenance action. Again, the objective is to avoid failure during field asset operation. Portable computer 30 is adapted to store the operational data such as hours, miles, etc. and retrieve planned maintenance based on the operational data. The third maintenance category is repair, which as result of a problem requires immediate attention due to a component failure that disables field asset or takes it out of service. With regular and timely predictive and preventive maintenance, the number of maintenance actions in the third category is desirably minimized.

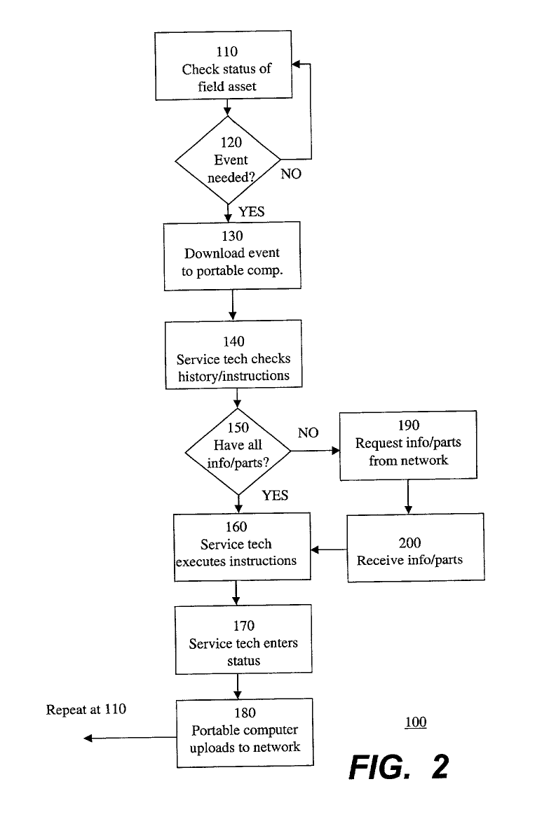

FIG. 2 illustrates an exemplary process flow 100 for maintenance management of a field asset employing aspects of the present invention. At step 110, portable computer 30 of FIG. 1 periodically queries communication network 16 (FIG. 1) to check the status of field asset 12 as described above, including operational parameter status checks (e.g. service miles, hours, etc.), recent maintenance instructions or service center requests. The periodic queries determine if a maintenance event or update to technical information is needed at step 120. If there is no event needed, either because a particular operational parameter is within acceptable limits or because there are no required maintenance events, then the query ends with no action required and periodic queries are performed at step 110. When it is determined that an event is needed, then communication network 16 (FIG. 1) downloads the maintenance instructions for the particular event needed to portable computer 30 (FIG. 1) at step 130. Upon access to the field asset, a service technician is able to view any recent instructions as downloaded above and the repair history of the field asset at 140. The service technician determines if he/she has all of the information needed to execute the maintenance instructions. If the instructions are readily understood and the service technician is able to perform the actions, then he/she executes the maintenance actions at step 160. If the service technician requires more detailed information (e.g. audio or video instructions due to the complexity of the needed action) from the service center or if he/she needs to order a part, he/she requests the needed information or parts via the communication device at step 190. Upon receipt of the needed information or parts at 200, he/she then proceeds to execute the maintenance actions. Upon completion of the maintenance actions, the service technician enters the status on portable computer 30 at step 170. Thereafter, portable computer 30 uploads the status of a completed maintenance action to communication network 16 at step 180. Thereafter, the process is repeated beginning with periodic queries at step 110.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

1. A maintenance management system for a given field asset comprising:
a portable computer with communication capability disposed on the field asset and adapted to store a maintenance history for the given field asset and further adapted to retrieve at least one of a plurality of maintenance information corresponding to the given field asset; and,
a communication network coupled to the portable computer and to at least one source of maintenance information to provide the at least one of a plurality of maintenance information for use in servicing the given field asset.

2. The system of claim 1 wherein the maintenance information comprises at least one of maintenance instructions, technical documentation for the field asset, repair and maintenance history records, and maintenance and repair status.

3. The system of claim 1 further comprising an on-board computing device further adapted to monitor operational parameters of the field asset and to communicate the operational parameters to the communication network.

4. The system of claim 3 wherein the portable computer and the on-board computing device are selected to withstand the environmental conditions of the field asset.

5. The system of claim 1 wherein the portable computer is further adapted to be removable from the field asset and configured to interface with the communication network via the on-board computing device in a wireless manner.

6. The system of claim 1 wherein the portable computer is configured to periodically query the communication network for at least one of maintenance instructions and updates to its technical information.

7. The system of claim 1 wherein the communication network is configured to import maintenance information from at least one of the sources.

8. The system of claim 1 wherein the portable computer is further adapted to permit service personnel to select maintenance instructions and record maintenance activities for the field asset.

9. The system of claim 1 wherein the portable computer is adapted to provide feedback of completion of a repair action to the communication network.

10. The system of claim 1 wherein the maintenance information comprises multimedia information.

11. The system of claim 10 wherein the multimedia information comprises at least one of still and video images, text instructions, schematics, drawings, instant messaging instructions and audio instructions.

12. The system of claim 1 wherein the communication network is coupled to at least one of a customer center, a service center, a parts requisition center and a configuration database.

13. The system of claim 1 wherein the portable computer is adapted to link to a bar code reader to decode bar-coded information during execution of a repair action.

14. A maintenance management system for a given field asset comprising:
an on-board computing device disposed on the field asset and adapted to store a maintenance history for the given field asset and further adapted to retrieve at least one maintenance instruction corresponding to the given field asset;
a plurality of sources of maintenance instructions; and,
a communication network coupled to the on-board computing device and to the plurality of sources of maintenance instructions to provide the at least one maintenance instruction for use in servicing the given field asset.

15. The system of claim 14 wherein the maintenance instructions comprise at least one of maintenance instructions, technical documentation for the field asset, repair and maintenance history records, and maintenance and repair status.

16. The system of claim 14 wherein the on-board computing device is further adapted to monitor operational parameters of the field asset and to communicate the operational parameters to the communication network.

17. The system of claim 14 wherein the on-board computing device is selected to withstand the environmental conditions of the field asset.

18. The system of claim 14 wherein the on-board computing device is further adapted to be removable from the field asset and configured to interface with the communication network in a wireless manner.

19. The system of claim 14 wherein the on-board computing device is configured to periodically query the communication network for maintenance instructions.

20. A method for maintenance management of a given field asset comprising:
storing a maintenance history on a computing device disposed on the field asset;
periodically querying a remote communication network for required maintenance events for the field asset;
retrieving the required maintenance events from the remote communication network for use in servicing the field asset; and,
updating the communication network from the computing device upon completion of the required maintenance events.
